(19) United States
(12) Patent Application Publication
(10) Pub. No.: US 2015/0078609 A1
(43) Pub. Date: Mar. 19, 2015

(54) VENT STRUCTURE FOR ELECTRO-ACOUSTIC PRODUCT, AN ELECTRO-ACOUSTIC PRODUCT HOUSING USING THE VENT STRUCTURE

(71) Applicant: MERRY ELECTRONICS (SUZHOU) CO., LTD., SUZHOU CITY (CN)

(72) Inventors: YING-HO TSENG, Taichung City (TW); YUNG-HO CHANG, Taichung City (TW); CAI-LI CHEN, Taichung City (TW); I-MING LIN, Taichung City (TW)

(73) Assignee: MERRY ELECTRONICS (SUZHOU) CO., LTD., SUZHOU CITY (CN)

(21) Appl. No.: 14/027,310

(22) Filed: Sep. 16, 2013

(51) Int. Cl. H04R 1/02

(52) U.S. Cl. CPC H04R 1/02
USPC 381/386

(57) ABSTRACT

A vent structure for electro-acoustic product includes a plastic member shaped like a tube and defining an opening, and a ventilation layer bonded to the plastic member using an insert molding technique and fully covered over the opening. Thus, the ventilation layer of the vent structure is more moisture-heat resistant in the environment and will not drop from the plastic member easily.

### BACKGROUND OF THE INVENTION

1. Field of the Invention

The present invention relates to plastic components for earphone, speaker and other electro-acoustic products, and more particularly to a plastic component embedded with a ventilation mesh by insert molding.

2. Description of the Related Art

Conventionally, an earphone, speaker or other electro-acoustic product generally has a ventilation structure for ventilation. A ventilation structure for this purpose is known comprising a plastic member and a ventilation mesh bonded to the plastic member using an adhesive or back glue. An adhesive or back glue for this application is a polymer composition, and its molecular structure can break easily when withstanding high temperature for a long time. Further, the adhesion capacity of the adhesive or back glue will be significantly decreased when softened by moisture in the environment, leading to dropping of the ventilation mesh out of the plastic member. To electro-acoustic products for outdoor use, moisture and high temperature in the outdoor environment are more likely to directly affect the bonding strength between the ventilation mesh and the plastic member, making the ventilation mesh easier to drop out of the plastic member, thereby affecting the durability.

### SUMMARY OF THE INVENTION

The present invention has been accomplished under the circumstances in view. It is the main object of the present invention to provide a vent structure formed of a ventilation layer and a plastic member for electro-acoustic product, which has the ventilation layer made more moisture-heat resistant in the environment, preventing dropping out of the plastic member.

To achieve this and other objects of the present invention, a vent structure for electro-acoustic product comprises a plastic member and a ventilation layer. The plastic member is shaped like a tube, defining an opening. The plastic member and the ventilation layer are bonded together using an insert molding technique, enabling the ventilation layer to fully cover the opening. Thus, the ventilation layer of the vent structure is more moisture-heat resistant in the environment and will not drop from the plastic member easily.

Preferably, the ventilation layer is selectively formed of one single piece of ventilation mesh or polyester film having good heat resistance and low water absorption.

Alternatively, the ventilation layer can be formed by bonding a ventilation mesh and a polyester film together.

Preferably, the ventilation layer is embedded in a mold, and then the plastic member is molded on the ventilation layer in the mold, and then the ventilation layer is trimmed along the outer perimeter of the opening, and the finished ventilation structure is thus obtained.

Preferably, the vent structure is used in an electro-acoustic product housing. The electro-acoustic product housing has at least one ventilation structure bonded thereto using an injection molding technique. The electro-acoustic product housing can be configured to provide an inner shell and an outer shell to have the at least one ventilation structure be bonded therebetween. Preferably, the inner shell and the outer shell are respectively molded on the at least one ventilation structure through a respective injection molding step.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a vent structure in accordance with a first embodiment of the present invention.

FIG. 2 is a schematic drawing illustrating the insert molding process of the fabrication of the vent structure in accordance with the first embodiment of the present invention.

FIG. 3 is an oblique top elevation of the vent structure in accordance with the first embodiment of the present invention.

FIG. 4 is a perspective view of a vent structure used in an electro-acoustic product housing in accordance with a second embodiment of the present invention.

FIG. 5 is a sectional view taken along line 5-5 of FIG. 4.

### DETAILED DESCRIPTION OF THE INVENTION

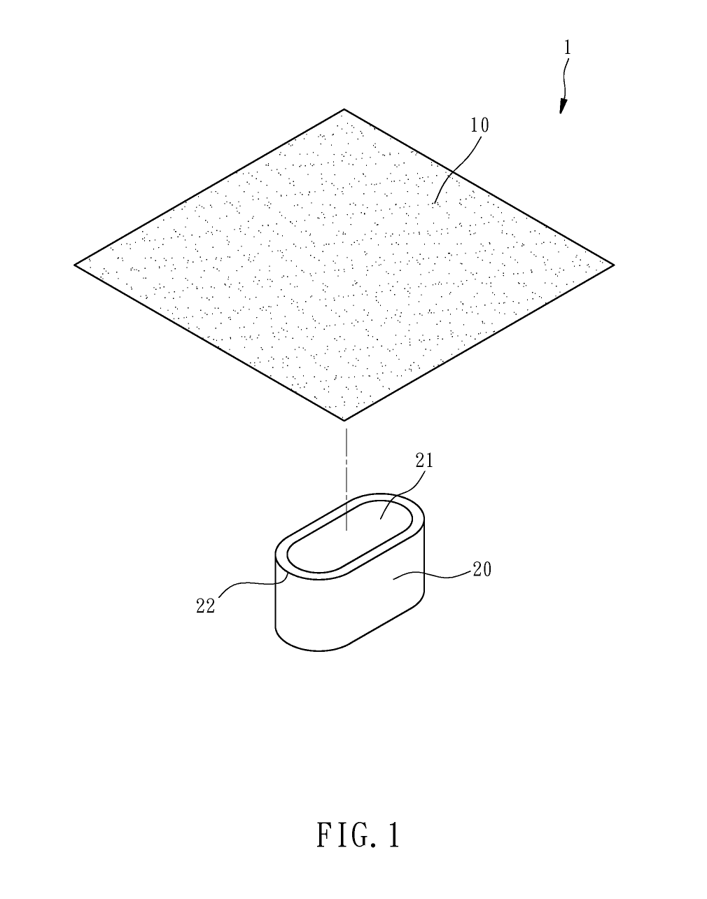

Referring to FIGS. 1-3, a vent structure for electro-acoustic product in accordance with a first embodiment of the present invention is shown. The vent structure comprises a ventilation layer 10 and a plastic member 20. The structure of these components and their relative relationship are described hereinafter.

As shown in FIG. 1, the ventilation layer 10 is a thin sheet member formed by bonding a polyester ventilation mesh and a polyester film together, having good heat resistance and low water absorption. Alternatively, the ventilation layer 10 can be formed of one single piece of ventilation mesh or polyester film.

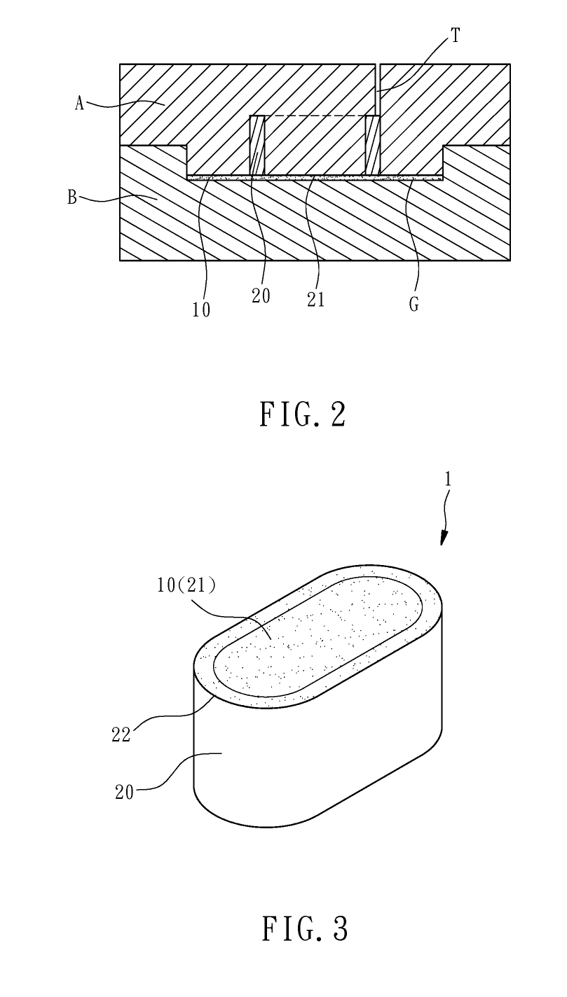

The plastic member 20 is shaped like a flat stub tube, defining an opening 21. The plastic member 20 and the ventilation layer 10 are bonded together using insert molding. As shown in FIG. 2, a male die B is shown providing a groove G. The ventilation layer 10 is put in the groove G, and then a female die A is closed on the female die B, and then a molten plastic is injected into a melt passage T in the female die A under an applied pressure, enabling the injected molten plastic to fill up the gap in between the female die A and the male die B, and then packing, cooling and shaping steps of insert molding are performed. After opened the female die A from the male die B, the desired flat stub tube-like plastic member 20 is thus obtained, and the ventilation layer 10 is completely bonded to the plastic member 20 and covered over the opening 21. Thereafter, a layer cutting technique is employed to trim the ventilation layer 10 along the outer perimeter 22 of the opening 21, and thus a finished ventilation structure 1 is obtained (see FIG. 3).

As stated above, the invention employs an insert molding technique to bond the ventilation layer 10 and the plastic member 20 together. When compared to conventional adhesive or back glue techniques, the ventilation layer 10 with the bonded plastic member 20 is more moisture-heat resistant in the environment, enhancing durability.

By the way, this embodiment employs an insert molding technique to make a ventilation structure 1. However, any person skilled in the art can use a mold to make multiple ventilation structures 1 at a time. Further, the ventilation layer 10 can be cut subject to a predetermined pattern prior to insert molding. Alternatively, one piece of ventilation layer 10 can be bonded between two plastic members 20 using an insert molding technique. Further, conventional cutting techniques using a regular cutting blade can be employed to trim the finished product instead of laser cutting.

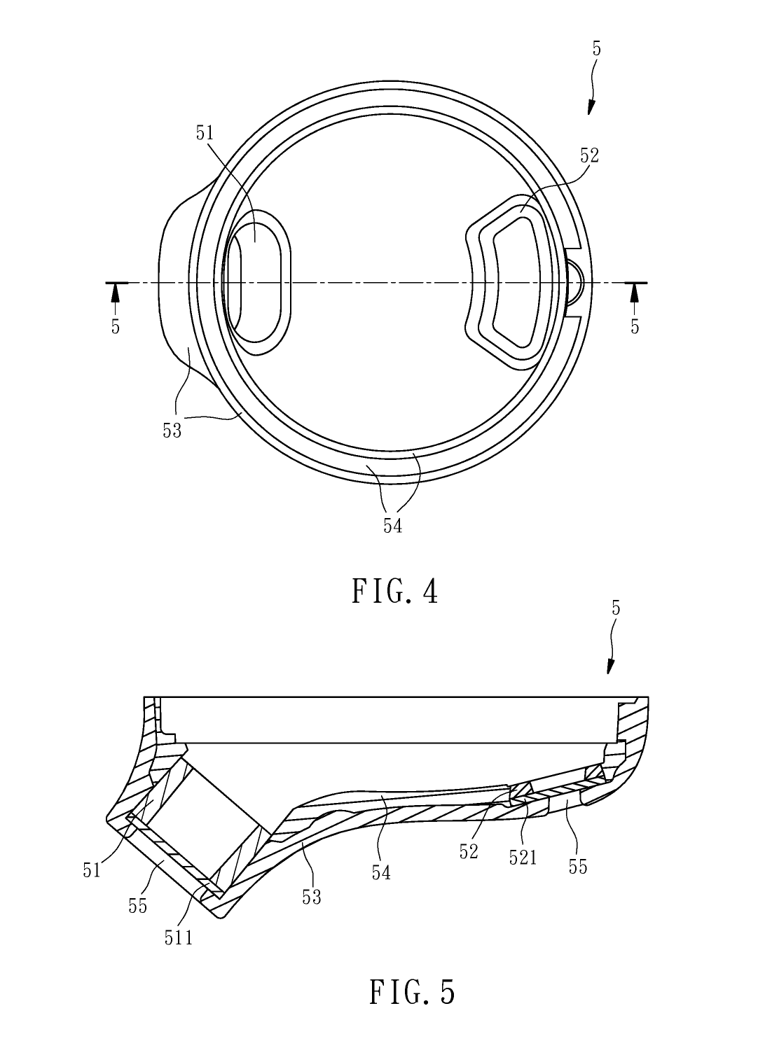

Referring to FIGS. 4 and 5, a ventilation structure 1 in accordance with a second embodiment of the present invention is shown for use in the housing 5 of an electro-acoustic product. The housing 5 comprises a first ventilation structure 51, a second ventilation structure 52, an outer shell 53, and an inner shell 54. The first ventilation structure 51 and the second ventilation structure 52 are respectively made in the same manner as the aforesaid first embodiment. The fabrication of the ventilation structure of this second embodiment is outlined hereinafter.

At first, a first ventilation structure 51 and a second ventilation structure 52 are prepared and then put in predetermined positions, and then an injection molding technique is employed to form an inner shell 54 on the first ventilation structure 51 and the second ventilation structure 52 at an inner side, and then another injection molding technique is employed to form an outer shell 53 on the first ventilation structure 51 and the second ventilation structure 52 at an outer side and to have the first ventilation structure 51 and the second ventilation structure 52 be bonded between the inner shell 54 and the outer shell 53, and thus a semispherical housing 5 is obtained, wherein the outer shell 53 defines two openings 55; the ventilation layer 511 of the first ventilation structure 51 and the ventilation layer 521 of the second ventilation structure 52 respectively faces toward the openings 55. Thus, an acoustic signal can pass through the ventilation layers 511 & 521 easily, and the ventilation layers 511 & 521 can isolate environmental dust particles and pollutants.

It is to be noted that any skilled in the art can make the housing 5 in a single shell structure to have the first ventilation structure 51 and the second ventilation structure 52 be embedded therein using one single injection molding process. Further, any perform skilled in the art can also employ ultrasonic insert techniques, or convex-concave mounting techniques to have the aforesaid components be bonded together.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vent structure for electro-acoustic product, comprising a plastic member and a ventilation layer, said plastic member being shaped like a tube and defining an opening, wherein said plastic member and said ventilation layer are bonded together using an insert molding technique, and said ventilation layer is fully covered over said opening.

2. The vent structure as claimed in claim 1, wherein said ventilation layer is selectively formed of one single piece of ventilation mesh or polyester film.

3. The vent structure as claimed in claim 1, wherein said ventilation layer is formed by bonding a ventilation mesh and a polyester film together.

4. The vent structure as claimed in claim 1, wherein said ventilation layer is embedded in a mold, and then said plastic member is molded on said ventilation layer in said mold, and then said ventilation layer is trimmed along the outer perimeter of said opening to obtain the finished ventilation structure.

5. An electro-acoustic product housing comprising at least one ventilation structure made as claimed in claim 1.

6. The electro-acoustic product housing as claimed in claim 5, wherein said housing has said at least one ventilation structure bonded thereto using an injection molding technique.

7. The electro-acoustic product housing as claimed in claim 6, further comprising an inner shell and an outer shell, wherein said at least one ventilation structure is bonded between said inner shell and said outer shell.

8. The electro-acoustic product housing as claimed in claim 7, wherein said inner shell and said outer shell are respectively molded on said at least one ventilation structure through a respective injection molding step.
